(19) United States
(12) Patent Application Publication
(10) Pub. No.: US 2010/0112025 A1
(43) Pub. Date: May 6, 2010

(54) Scented oil for application to a hunter's body

(76) Inventors: Clinton W. Farris, Hillsville, VA (US); Myra A. Martin, Hillsville, VA (US)

Correspondence Address: THE INVENTORS NETWORK, INC., 332 ACADEMY STREET, CARNEGIE, PA, 15106, US

(21) Appl. No.: 12/290,823

(22) Filed: Nov. 5, 2008

(51) Int. Cl. A01N 25/34

(52) U.S. Cl. 424/411

(57) ABSTRACT

A composition for reducing or eliminating the exudation of human skin cells for inhibiting the scent of a human body from being detected by wildlife is produced by soaking at least three scented wafers each imitating a light natural fragrance in a container filled with generic mineral oil for a given time period with the scented wafers selected from a number of natural fragrances and the wafers are left soaking in the mineral oil until their scent sufficiently disperses throughout and permeates the mineral oil whereupon the oil suffused with the scent is poured into a smaller container such as spray bottle whereupon the individual sprays the mineral oil with the infused scent on his or her body prior to entering a wilderness area so that the individual's scent will be inhibited and reduced thereby allowing the individual to more closely approach undetected the wildlife for hunting, photography, or observation purposes.

### FIELD OF THE INVENTION

The present invention pertains to odor suppressants, and more particularly pertains to scented oil for inhibiting and reducing the scent produced by the body of a hunter.

### BACKGROUND OF THE INVENTION

Whether an individual is hunting, photographing or just observing wildlife, one of the most elementary difficulties for engaging in such activities is to simply get close to the wildlife. Given the keen sense of smell, sight, and sound that animals possess, utmost care and precaution must be exercised if one is to approach wildlife to engage in any of the above activities. Because of the heightened sensory qualities of wildlife, numerous devices and means have been devised to approach wildlife of all types and varieties with as little commotion, disturbance, or advance indication as possible.

For example, camouflage blinds are commonly used by hunters and photographers to disguise their locations and allow wildlife to approach in close proximity thereto. However, blinds can sometimes be bulky and require time to set up, break down and transport from site to site. In addition, simpler and less expensive camouflage techniques include camo outfits that include boots, pants, vest, coat and jacket and camouflage tree stands. However, the aforementioned devices and techniques only apply to visual concealment means; there still remains the problem of how to disguise, cloak or conceal one's smell as the scent exuded by a human can be an even more distinctive precursor to the presence of a human being than the actual visual detection by the particular type or species of wildlife. Since many species of wildlife have a much keener sense of smell than of sight, the presence of a human being is often detected far in advance of any visual detection. As a consequence, additional concealment or disguise techniques and strategies must be employed some of which include odor suppressants that are applied to the clothing, weapons, equipment, cameras, and even the body of the individual—whether that individual is a hunter, a wildlife or nature photographer or just an individual whose hobby or avocation is the observation of wildlife.

For example, the Hussain et al. patent (U.S. Pat. No. 4,552,693) discloses transparent fragrance emitting articles that are formed from a composition that includes a thermoplastic polyamide resin plasticizer.

The Bethshears patent (U.S. Pat. No. 4,828,829) discloses a fish attractant with sensory enhancements that includes oil-based fish attractant compositions and light-reflective particles that act as visual attractants.

The Hoang et al. patent (U.S. Pat. No. 5,817,344) discloses a non-aqueous emollient iodophor formulations for use as skin-washing agents that include non-ionic surfactants.

The Bailey et al. patent (U.S. Pat. No. 5,833,992) discloses a native herbal coverscent that provides an effective mask for a human scent and which includes a water-based solution combined with a certain type of flora.

The Unser patent (U.S. Pat. No. 5,897,853) discloses a fingernail conditioning system that includes composition of minerals, vitamins, amino acids, aromatic scents and an adhesive.

The Weiser patent (U.S. Pat. No. 6,149,901) discloses an animal scent enhancer that attracts animals through a composition of various types of matter.

The Messina patent (U.S. Pat. No. 6,385,508 B1) discloses an animal repellant and method for specifically warding off geese or deer from a shrub or plant.

Nonetheless, despite the ingenuity of the above compositions, there remains a need for a product that reduces and inhibits the exudation of human scent while in the outdoors hunting, photographing or observing wildlife.

### SUMMARY OF THE INVENTION

The present invention comprehends a composition that is applied to the body of an individual, such as a hunter, a photographer, or an observer of wildlife, to inhibit the detection of human scent by wildlife. The composition acts as a scent inhibitor and not as a cover scent by greatly reducing or eliminating the exudation or loss of human skin cells that are the means by which wildlife detect the presence of a human being.

The composition is produced by soaking at least three scent wafers imitating a light natural fragrance in a container of generic mineral oil for a given time period. The scent wafers can be selected from a number of natural fragrances and the wafers are left soaking until their scent sufficiently disperses throughout and permeates the mineral oil. The mineral oil suffused with the given scent is then poured into a smaller container whereupon the individual sprays the scented oil onto his or her body prior to entering a wilderness or outdoor area. The scented wafers retain enough of their scent that they can be used a second time.

It is an objective of the present invention to provide a scented oil that is applied to a hunter's body for reducing the scent exuded by the hunter.

It is another objective of the present invention to provide a scented oil that is applied to the hunter's body through the use of a spray bottle.

It is yet another objective of the present invention to provide a scented oil for application to the body of the hunter in which the scent can be selected from one of a number of particular scents.

It is still yet another objective of the present invention to provide a scented oil for application to the hunter's body wherein the scented oil reduces or greatly eliminates the amount of skin cells that are shed, exuded or lost thereby reducing or eliminating the exudation of the human scent from the hunter.

It is still yet a further objective of the present invention to provide a scented oil for application to the body of an individual wherein the individual can be a hunter, a photographer or an observer of wildlife.

Still another objective of the present invention is to provide a scented oil for application to the body of the hunter that imitates the light fragrances produced by nature.

Still yet another objective of the present invention is to provide a scented oil for application to the body of a hunter wherein the scented oil acts as a scent inhibitor and not a cover scent.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

### DETAILED DESCRIPTION OF THE PREFERRED EMBODIMENT

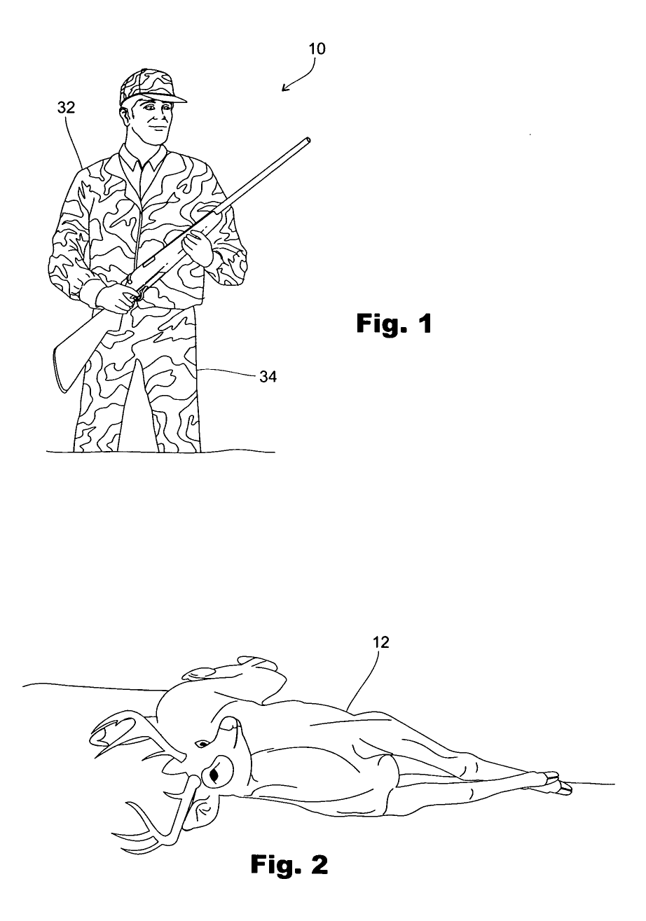

Illustrated in FIGS. 1-9 is a preferred embodiment of a method and product for creating a composition that is applied to the body of an individual to greatly reduce, inhibit, and eliminate the amount and number of human skin cells that are shed or exuded for reducing the human scent of the individual in an outdoor or wildlife situation that involves such activities as hunting, photographing or observing wild animals. By applying the composition of the present invention, the individual can more closely approach wildlife in an outdoor setting as the smell or scent exuded by a human being—the individual—is readily and quickly detected by animals to alert them that a foreign presence is approaching or is entering their range or territory. Thus, FIG. 1 one shows a representative individual 10 in the form of a hunter, and for which the composition is designed; and FIG. 2 illustrates a representative wildlife 12 in the form of a typical North American deer. It should be noted that the composition is a scent inhibitor and not a cover scent, and it is pleasant to wear and easy to both apply and remove.

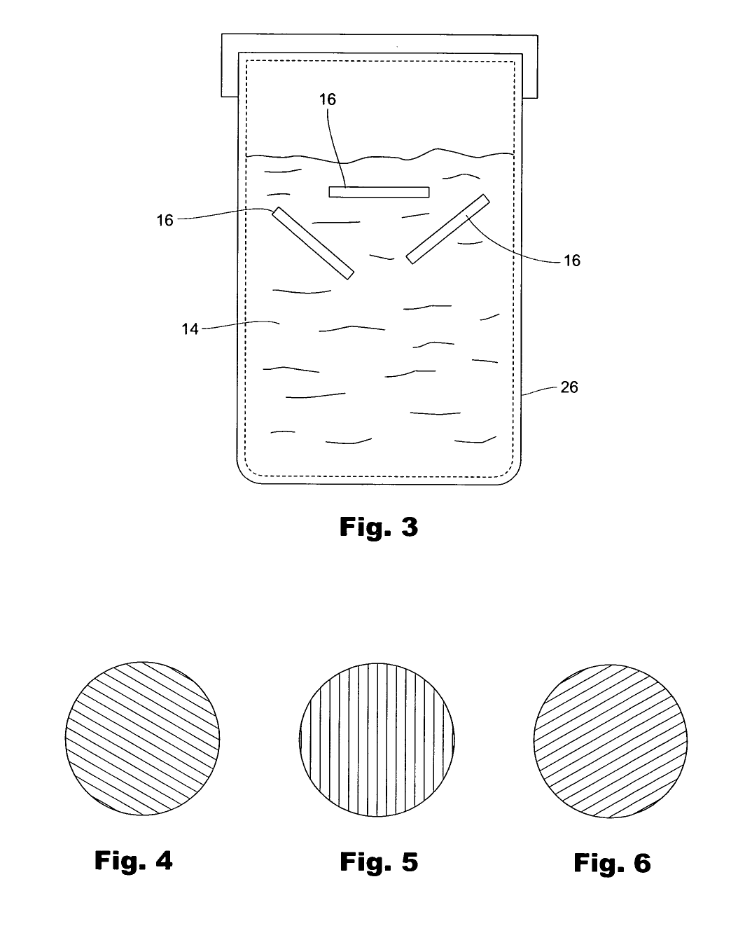

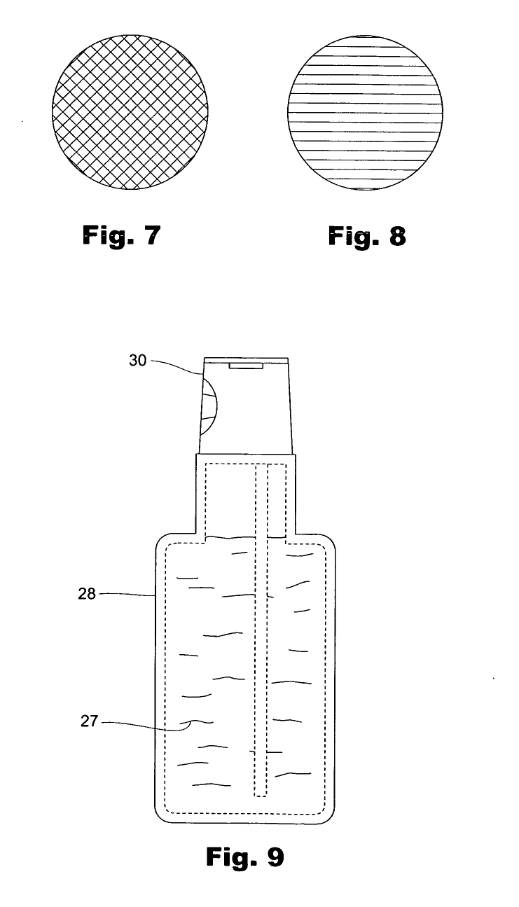

Thus, as shown in FIGS. 3-9, the scent inhibitor composition includes a generic mineral oil 14 that is infused, saturated or permeated with a particular scent, with the scent preferably being drawn or selected from the many natural fragrances found in nature. The particular fragrance or scent is infused in the mineral oil 14 by soaking scented wafers in a volume or quantity of generic mineral oil. The scented wafers can be infused or permeated with a number of natural fragrances with FIG. 4 illustrating one scented wafer 16 having a white oak acorn scent or fragrance, FIG. 5 illustrating one scented wafer 18 having a fresh earth fragrance or scent, FIG. 6 illustrating one scented wafer 20 having a natural pine scent or fragrance, FIG. 7 illustrating one scented wafer 22 having a natural cedar scent or fragrance and FIG. 8 illustrating one scented wafer 24 having a western sage fragrance or scent.

With reference to FIGS. 3-9, the process for producing the scent inhibiting composition is as follows. First, a quantity of generic mineral oil 14 is placed into a covered plastic container 26 with the preferred quantity of mineral oil 14 being at least 473 milliliters of generic mineral oil 14. At least three scented wafers 16-24 (all of the same scent), as shown in FIGS. 4-8, are placed in the container 26 for infusion or suffusion throughout the mineral oil 14. For representative purposes, the three scented wafers shown in the plastic container 26 of FIG. 3 are the scented wafers 16 having the white oak acorn fragrance. Whatever scented wafers 16-24 are used, they are left soaking in the container 26 for at least seven days for complete and thorough infusion or suffusion throughout the body or quantity of the generic mineral oil 14 thereby producing the scented oil composition 27. After seven days the mineral oil 14 is then removed from that plastic container 26 and poured into another container. One type of preferred container 28 shown in FIG. 9 is a generic two-ounce spray bottle having a removable spray bottle lid 30. The spray bottles 28 are lightweight and can be easily and unobtrusively carried in any of the flaps and pockets of the hunting vest or jacket 32, or in pouches or pockets located on the hunting pants 34. The scented wafers 16-24 can then be re-used a second time to create a second batch of the scent inhibiting composition 27.

In order to use the scent inhibiting composition 27 of the present invention, the individual 10 such as the hunter shown in FIG. 1 prepares for hunting in the normal fashion such as using scent-free soaps, detergents, deodorant shampoo and exfoliates for the skin. The scented wafers 16-24 themselves are not to be used on one's clothing 32 and 34 or body. Finally, the individual 10 such as the hunter shown in FIG. 1, sprays the scented mineral oil composition 27 using the spray bottle 28 into his or her hand and then rubs the composition 27 onto his/her body repeating the above as necessary for full body coverage.

It should be noted that the scent wafers 16-24 when combined with the generic mineral oil 14 imitate or mimic the many light fragrances found in nature. The scented wafers 16-24 alone are much too strong and will alert wildlife that something different has entered or is in their territory. The generic mineral oil 14 greatly reduces or eliminates the loss of human skin cells; and it is the loss and dispersal of human skin cells that are the mechanism by which human scent is detected by wildlife. Thus, the creation and application of the composition 27 of the present invention to the body of the individual 10 facilitates the reduction or elimination of this scent detection by wildlife, and thus can make humans invisible to wildlife when humans enter the domain of wildlife so they can approach wildlife without detection.

It is to be understood that the forms of this invention described are the preferred embodiment thereof and that numerous modifications, alterations, and variations may be made therein without departing from the spirit of the invention or scope thereof as defined by and in the following appended claims.

We claim:

1. A scented oil composition for application to the body of the individual to inhibit the dispersal of human scent in an outdoor setting, comprising:
a quantity of generic mineral oil;
a plurality of scented wafers soaked in the generic mineral oil for saturation throughout the generic mineral oil;
the scented wafers having a light natural fragrance; and
a spray bottle within which the quantity of generic mineral oil saturated with the natural fragrance of the scented wafers whereupon the individual can apply the scented oil composition to his body by spraying the scented oil composition into his hand and then rubbing his hand with the scented oil composition on his body.

2. The scented oil composition of claim 1 wherein the light natural fragrance of the scented wafers includes a white acorn fragrance.

3. The scented oil composition of claim 2 wherein the light natural fragrance of the scented wafers includes a fresh earth fragrance.

4. The scented oil composition of claim 3 wherein the light natural fragrance of the scented wafers includes a natural pin fragrance.

5. The scented oil composition of claim 4 wherein the light natural fragrance of the scented wafers includes a natural cedar scent.

6. The scented oil composition of claim 5 wherein the light natural fragrance of the scented wafers includes a western sage fragrance.

7. A process for creating a scented oil composition that comprises the steps of:
placing at least 473 milliliters of generic mineral oil in a covered plastic container;
placing at least three scented wafers in the generic mineral oil so that the particular fragrance of the scented wafers can suffuse throughout the generic mineral oil;
leaving the scented wafers soaking in the generic mineral oil for at least seven days; and
pouring the generic mineral oil with the fragrance of the scented wafer suffused throughout in a two-ounce spray bottle so that the individual can apply the scented oil composition to his body as needed for inhibiting the dispersal and exudation of human scent so that the individual can approach wildlife undetected.
